(19) United States
(12) Patent Application Publication
(10) Pub. No.: US 2004/0212855 A1
(43) Pub. Date: Oct. 28, 2004

(54) Automatic document feeder

(75) Inventor: Kiyoshi Okamoto, Tokyo (JP)

Correspondence Address: Canon U.S.A. Inc., Intellectual Property Department, 15975 Alton Parkway, Irvine, CA, 92618-3731, US

(73) Assignee: Canon Kabushiki Kaisha, Tokyo (JP)

(21) Appl. No.: 10/821,348

(22) Filed: Apr. 9, 2004

(30) Foreign Application Priority Data
Apr. 24, 2003 (JP) 2003/119355

(51) Int. Cl. G03G 15/00; H04N 1/04

(52) U.S. Cl. 358/498; 399/16

(57) ABSTRACT

An automatic document feeder for feeding a batch of documents to an imaging device. The automatic document feeder includes a controller for controlling separation of documents from the batch of documents based on whether material type of the batch of documents is either color-recorded paper or normal paper. The controller also controls separation based on whether the imaging device has color recording capabilities or whether the recording mode has been set to either a color recording mode or a monochrome recording mode. When the documents are color-recorded paper or the mode of recording is color recording, the controller sets the separation interval of subsequent documents longer than when the documents are normal paper or the mode of recording is monochrome recording, thereby preventing collision of a preceding document and a subsequent document and thus preventing a decrease in productivity during monochrome printing.

### BACKGROUND OF THE INVENTION

1. Field of the Invention

The present invention relates to document separation control in an automatic document feeder.

2. Description of the Related Art

Some image readers of digital compound machines, printers, facsimiles, and the like include an automatic document feeder (ADF). The automatic document feeder automatically feeds sheet documents to the image reader such that it can freely be switched.

Flow reading is a reading method using an image reader having the ADF that is well known in the art. Flow reading involves an image-reading optical system fixed to a specified reading position of a platen glass of the image reader. The documents are moved to the reading position at a constant speed. The flow reading system has the advantage of a high document replacement speed. This system is used in a large number of products as a reading method for processing a large amount of sheet documents at a high speed. The method allows reading capacity to be increased by continuous document feeding. Specifically, a batch of documents on a document tray are carried to a separating section where the documents are separated one by one. A register section corrects the bias of the documents. Then, the documents are carried to a reading position at a specified interval.

Subsequent documents are fed when the trailing edge of the preceding document has passed through a register sensor or a dedicated sensor on the register sensor (for example, refer to U.S. Pat. No. 6,151,478).

With the above-mentioned system, the feeding operation for the subsequent document is started when the trailing edge of the preceding document has passed through the register sensor, which increases the document spacing between the trailing edge of the preceding document and the leading edge of the subsequent document. As such, it has been difficult to increase document feeding efficiency.

A solution for the above-described problem involves feeding the subsequent document before the trailing edge of the preceding document reaches the register sensor (for example, refer to Japanese Patent Laid-Open No. 2002-002984).

However, if after starting separation of the subsequent document, the preceding document stops temporarily before the reading position, for example, to allocate a storage area for the read document image in a memory, the subsequent document must be stopped temporarily at the separating section to prevent collision with the preceding document. In this case, when the temporarily stopped document is an oil-coated color document or a specially coated document for color printing, the document could stick to a separating member. As such, the temporarily stopped color document may not be carried even when feeding resumes.

Another proposal for controlling feed timing of a plurality of documents depends on whether the documents have punched holes and on the position of the punched holes (for example, refer to Japanese Patent Laid-Open No. 09-222752).

In the above-mentioned related art, however, the material type of the documents are not taken into account.

### SUMMARY OF THE INVENTION

The present invention is directed to an automatic document feeder and a method for controlling the same in which the above-described problems are solved.

In one aspect of the present invention, the automatic document feeder separates documents based on material types of the documents. In one embodiment of the present invention, the automatic document feeder is capable of feeding a batch of documents of varying material types to a document reader of an imaging device, the automatic document feeder comprising a document tray supporting the batch of documents thereon; a separator separating a document from the batch of documents on the document tray; an input device receiving data on the material type of the batch of documents; and a separation controller operatively coupled to the separator and in communication with the input device, wherein the separation controller drives the separator to initiate separation of a document from the batch of documents in response to data received from the input device.

In another aspect of the present invention, the automatic document feeder separates the documents based on the image recording mode. In one embodiment of the present invention, the automatic document feeder is capable of feeding a batch of documents to a printer capable of selectively recording images in a color recording mode or a monochrome recording mode, the automatic document feeder comprising a document tray supporting the batch of documents thereon; a separator separating a document from the batch of documents on the document tray; an input device receiving data on the selected recording mode, including the color recording mode or the monochrome printing mode; and a separation controller operatively coupled to the separator and in communication with the input device, wherein the separation controller drives the separator to initiate separation of a document from the batch of documents in response to data received from the input device.

In another embodiment of the present invention, the automatic document feeder is capable of feeding a batch of documents to a printer, the automatic document feeder comprising a document tray supporting the batch of documents thereon; a separator separating a document from the batch of documents on the document tray; and a detector detecting a capability of the printer to record in color; and a separation controller operatively coupled to the separator and in communication with the detector, wherein the separation controller drives the separator to initiate separation of a document from the batch of documents in response to the capability detected by the detector.

### BRIEF DESCRIPTION OF THE DRAWINGS

FIG. 1 is a schematic view of an imaging device incorporating an automatic document feeder in accordance with one embodiment of the present invention.

FIG. 2 is a block diagram of a controller controlling the imaging device shown in FIG. 1.

FIG. 3 is a schematic view of the automatic document feeder in accordance with one embodiment of the present invention.

FIG. 4 is a diagram of an operation display unit shown in FIG. 1.

FIGS. 5-8 are diagrams showing stages of a separation feeding operation.

FIG. 9 is a schematic view of an automatic document feeder in accordance with another embodiment of the present invention.

FIGS. 10-14 are drawings of example screens displayed on the operation display unit shown in FIG. 1.

FIG. 15 is a flowchart for setting a feeding mode in accordance with one embodiment of the present invention.

FIG. 16 is a flowchart for setting a feeding mode in accordance with another embodiment of the present invention.

FIG. 17 is a flowchart for setting a feeding mode in accordance with another embodiment of the present invention.

FIG. 18 is a flowchart for setting a feeding mode in accordance with another embodiment of the present invention.

FIG. 19 is a flowchart for setting a feeding mode in accordance with another embodiment of the present invention.

FIG. 20 is a flowchart for a separating operation in accordance with one embodiment of the present invention.

### DESCRIPTION OF THE PREFERRED EMBODIMENT

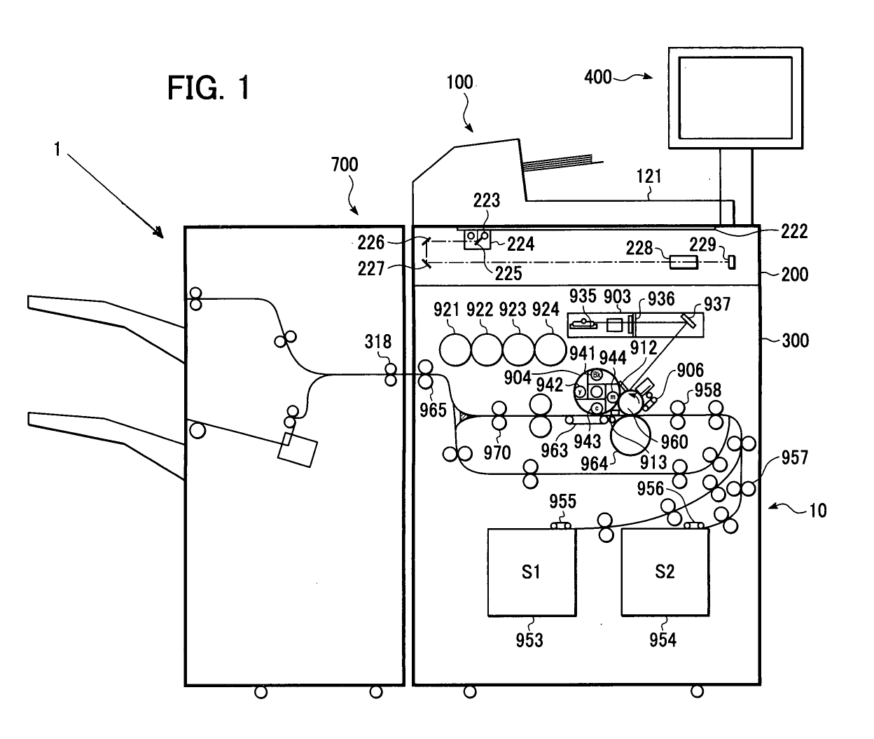

An embodiment of the present invention will be described hereinafter. FIG. 1 is a schematic diagram of an imaging device 1 incorporating an automatic feeder 100 in accordance with one embodiment of the present invention.

[General Structure]

Referring to FIG. 1, the imaging device 1 includes an imaging-device body 10 and a finisher 700. The imaging-device body 10 includes an image reader 200, for reading a document image, and a printer 300.

The image reader 200 includes an automatic document feeder 100. The automatic document feeder 100 feeds documents that are placed on a document tray to the left one by one, carries them through a curved path from the left through a flow reading position to the right on a platen glass 222, and then ejects them toward an output tray 121. As the documents pass through the flow reading position to the platen glass 222, the document images are read by a scanner unit 224 at a position corresponding to the flow reading position. This reading method is generally called a document-flow reading method. The automatic document feeder 100 will be more specifically described later.

When a document passes the flow reading position, the read face of the document is irradiated with light from a lamp 223 in the scanner unit 224. Light reflected from the document face is focused into a lens 228 via mirrors 225, 226, and 227. The light passing through the lens 228 is imaged on an imaging face of an image sensor 229.

As mentioned, the documents are carried from left to right in the flow reading position. A document reading scan perpendicular to the document carrying direction (main scanning direction) and a document reading scan along the carrying direction (subscanning direction) are performed. Specifically, as a document passes the flow reading position, the document is carried in the subscanning direction while the image sensor 229 reads the entire document image line-by-line in the main scanning direction. The image sensor 229 converts the optically read image into image data and outputs the image data. An image signal controller 202 processes the image data outputted from the image sensor 229, which is then inputted as a video signal to an exposure controller (not shown) of the printer 300.

The printer 300 includes a plurality of recording paper cartridges 953 and 954 capable of housing recording paper S of different sizes and recording-paper feeding sections 955 and 956 for feeding recording paper. The fed sheets S are carried along a sheet carrying path 957 and a sheet carrying path 958.

A laser output section (not shown) in an exposure means, such as a laser-exposure optical system 903, converts the image signal to a light signal. The light signal is reflected by a polygon mirror 935, passes through a lens 936, reflects off a mirror 937, and is projected onto an exposure position on a surface of a photoconductor drum 960.

The photoconductor drum 960 is supported so as to rotate in the direction of the arrow shown in the drawing. Disposed around the drum 960 are the exposure means 903 (the laser-exposure optical system), a potential sensor 912, a movable body (developing rotary) 904 which is a rotary developer holder, four developing units/sections 941 to 944 accommodating developers of different colors in their respective holders, a transfer drum 964, a separator 913, and a cleaner 906.

The movable body 904 has a magenta developing section 944, a cyan developing section 943, a yellow developing section 942, and a black developing section 941. The four developing units are alternately brought into contact with the photoconductor drum 960 to develop an electrostatic latent image on the photoconductor drum 960 with respective color toners.

As shown in the drawing, the toners in the processors 941 to 944 are supplied from respective-color toner cartridges (hoppers) 921 to 924 as necessary at desired timing so as to keep the toner ratio (or toner amount) in the processors constant.

The transfer drum 964 winds the fed sheet S around the transfer drum 964 in order to transfer the developed image on the photoconductor drum 960 to the sheet S. After the four colors (M, C, Y, and Bk) have been transferred in sequence, the separator 913 separates the sheet S from the transfer drum 964. The sheet S is carried through a conveyor belt 963 and a fixing unit 970. A feed roller 965 then carries the sheet S to a carrying path 318 of the finisher 700.

[System Block Diagram]

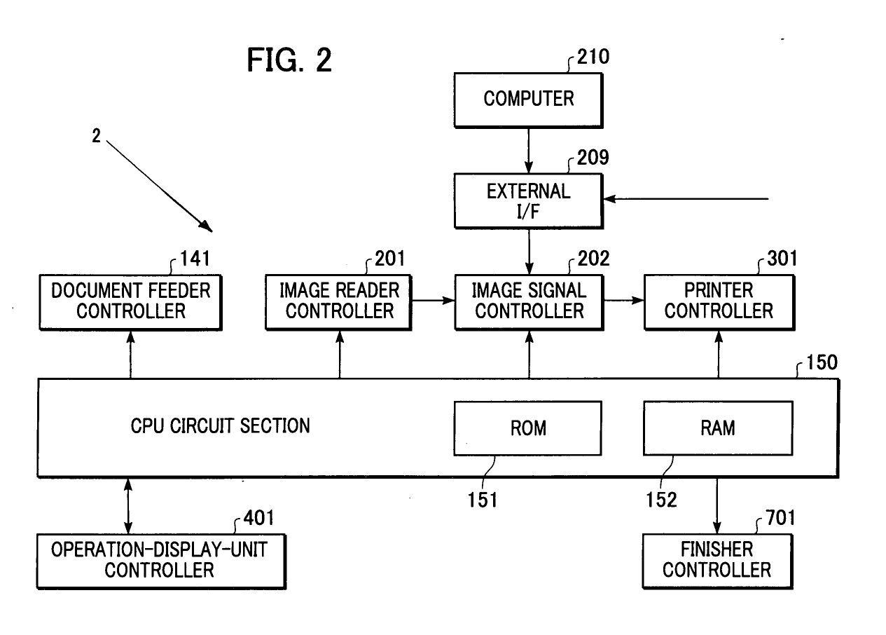

Referring now to FIG. 2, the structure of a controller 2 for controlling the entire imaging device 1 will be described. FIG. 2 is a block diagram of the controller 2 for controlling the entire imaging device of FIG. 1.

The controller 2 includes a CPU circuit section 150. The CPU circuit section 150 includes a CPU (not shown), a ROM 151, and a RAM 152. The CPU circuit section 150 controls other components of the controller 2, including a document feeder controller 141, an image reader controller 201, an image signal controller 202, an external I/F 209, a printer controller 301, an operation-display-unit controller 401, and a finisher controller 701. A control program is stored in the ROM 151. The RAM 152 temporarily stores control data and is used as a working area for data processing along with the control.

The document feeder controller 141 controls the automatic document feeder 100 in accordance with instructions from the CPU circuit section 150. The image reader controller 201 controls the scanner unit 224 and the image sensor 229 in order to transfer an analog image signal outputted from the image sensor 229 to the image signal controller 202.

The image signal controller 202 converts the analog image signal from the image sensor 229 into a digital signal, converts the digital signal into a video signal, and then outputs the video signal to the printer controller 301. The image signal controller 202 also converts digital signals inputted from a computer 210 through the external I/F 209 into a video signal and outputs the video signal to the printer controller 301. The CPU circuit section 150 controls the operation of the image signal controller 202. The printer controller 301 drives the above-mentioned exposure controller 310 in accordance with the inputted video signal.

The operation-display-unit controller 401 exchanges information between an operation display device 400 (shown in FIG. 1) and the CPU circuit section 150. The operation display device 400 includes multiple keys for setting various functions on imaging and a display for displaying information on a setting state. The device 400 outputs a key signal corresponding to the key operation to the CPU circuit section 150 and displays corresponding information on the display in accordance with the signal from the CPU circuit section 150.

The finisher controller 701 is mounted to the finisher 700 and controls the entire finisher 700 by exchanging information with the CPU circuit section 150.

[Description of Automatic Document Feeder]

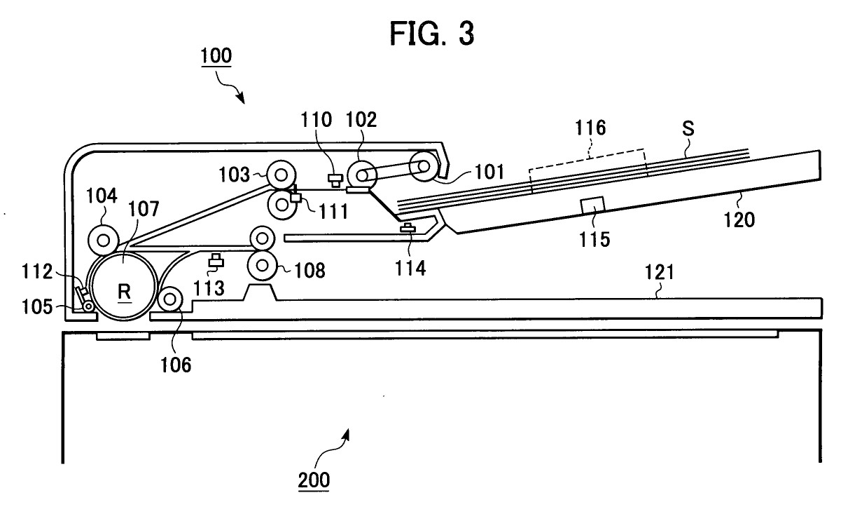

Referring to FIG. 3, the automatic document feeder 100 will be described. FIG. 3 is a schematic diagram of the automatic document feeder 100 in accordance with one embodiment of the present invention.

The automatic document feeder 100 includes a document tray 120 which supports a batch of documents S. The automatic document feeder (ADF) 100 includes a pickup roller 101 which feeds documents starting from the uppermost document of the batch of documents S towards a separator 102, with the surface up. The separator 102 has an upper separating roller and a lower separating pad, which separates the batch of documents S one by one starting from the upper most sheet.

Before images on a single-sided document are read, the separated documents undergo bias correction during separation feeding via a first register roller 103, then carried to a second register roller 104, then carried to a first feed roller 105, and then carried to a reading position R where the images on the surface of the document are read. After passing a second feed roller 106, a paper-expelling roller 108 ejects the document onto an output tray 121, with the surface down.

When images on the front and back sides of a double-sided document are read, the separated document undergo bias correction during separation feeding via the first register roller 103. The separated document then passes through the second register roller 104, the first feed roller 105, the second feed roller 106, and then to the reading position R where the image on the front surface is read. The document passes the second feed roller 106, and then the paper-expelling roller 108 expels the document such that the leading edge of the document temporarily projects onto the output tray 121 but the trailing edge is nipped by the paper-expelling roller 108.

The document is then carried in a switchback manner, and again undergoes bias correction via the second register roller 104. The first feed roller 105 and the second feed roller 106 then carry the document to the reading position R, where the image on the rear surface is read.

If the document is outputted from the second feed roller 106 onto the output tray 121 by the paper-expelling roller 108, with the surface face up, the surface would be different from that placed on the document tray 120. Accordingly, the document whose back image is read is carried again by the second feed roller 106 and the paper-expelling roller 108 such that the leading edge of the document projects onto the output tray 121, but the trailing edge of the document is nipped by the paper-expelling roller 108. The document is then carried by the second register roller 104, the first feed roller 105, and the second feed roller 106 in switchback manner and outputted sequentially onto the output tray 121 by the paper-expelling roller 108 with the front surface face down. However, while the document is being fed in the reading position R, the document image is not being read.

A document-set sensor 114 detects whether or not documents are set on the document tray 120. A pair of cross-directional aligning plates 116 is provided on the document tray 120. The aligning plates 116 are slidable along the width of the batch of documents S for controlling the width of the batch of documents S placed on the document tray 120 from both sides to ensure stability of the batch of documents S during feeding.

As the pair of cross-directional aligning plates 116 is moved, four inner slide switches 115 are turned on and off depending on the position of the cross-directional aligning plates 116. The width of the documents can be determined based on the condition of the switches 115.

A separation sensor 110, a register sensor 111, a read sensor 112, and a paper-output sensor 113 detect the fed document in order to determine the document feeding condition and the length of the document in the feeding direction.

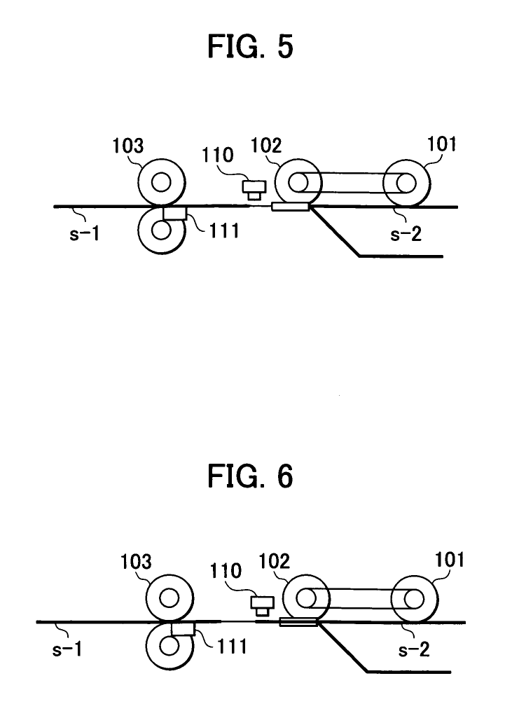

Referring now to FIG. 3 and FIGS. 5-8, the separation operation will be described. In FIGS. 5-8, reference numbers s-1 and s-2 denote two documents which are fed consecutively, numeral s-1 indicating a first fed document and numeral s-2 indicating a subsequently fed document.

As a pickup motor (not shown) rotates, the pickup roller 101 rotates to move onto the batch of documents S and the separating roller of the separator 102 rotates. Only the uppermost document of the batch of documents S is carried by the upper separating roller and the lower separating pad of the separator 102.

The leading edge of the separated document is detected by the separation sensor 110. When the leading edge of the document is detected by the register sensor 111, the pickup motor is stopped to thereby stop the pickup roller 101 and the separating roller of the separator 102. At that time, the leading edge of the document is brought into contact with the first register roller 103, so that the bias correction of the document is performed.

The register sensor 111 includes a retractable flag and an optical sensor for detecting the presence of a fed document. The register sensor 111 detects the leading edge of the document a few millimeters before the leading edge of the document reaches the first register roller 103. The register sensor 111 detects the trailing edge of the document when the trailing edge passes through the first register roller 103.

A paper feed motor (not shown) is activated to rotate the first register roller 103. A read motor (not shown) is activated to rotate the second register roller 104 and the first feed roller 105. Accordingly, the document is fed to the reading position R with the first register roller 103, the second register roller 104, and the first feed roller 105.

The automatic document feeder 100 has an automatic document feeding mode corresponding to the material of the document, one of which is a color-only-paper-document feeding mode. This mode is principally used for sticky paper such as recording paper on which an image has formed by an electrophotographic color imaging device, as the documents.

When the trailing edge of the separated document s-1 is detected by the separation sensor 110 and when the feeding mode is not the color-only-paper-document feeding mode, the pickup motor is again rotated to rotate the separating roller of the separator 102, thereby feeding the following uppermost document s-2 of the batch of documents S to the separator 102 (refer to FIG. 5). The leading edge of the separated document s-2 is detected by the separation sensor 110 (refer to FIG. 6).

At this point, continued feeding of the preceding document s-1 may stop if it takes too much time to ensure a storage area of a read-image memory before image reading or when an optimum paper size for imaging has not been placed. Therefore, in order to prevent the collision between the preceding document s-1 and the following document s-2, if the leading edge of the following document s-2 has been detected but the trailing edge of the preceding document s-1 has not been detected by the register sensor 111, the pickup motor is stopped to stop the rotation of the pickup roller and the separating roller of the separator 102, thereby temporarily stopping the feeding of the following document s-2. Thereafter, when the trailing edge of the preceding document s-1 has been detected by the register sensor 111, the pickup motor is again rotated to restart the feeding of the following document s-2. When the leading edge of the following document s-2 has been detected by the register sensor 111, the pickup motor is stopped to stop the rotation of the pickup motor and the separating roller, and the bias correction of the following document s-2 is performed (refer to FIG. 8).

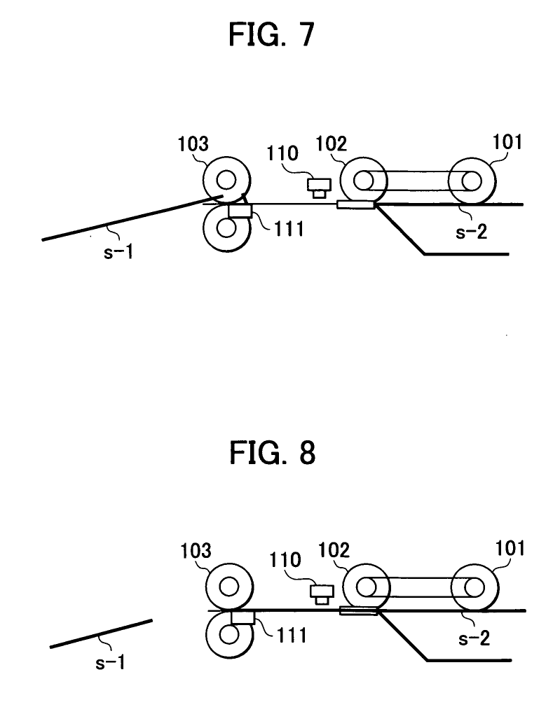

When the feeding mode is the color-only-paper-document feeding mode, the pickup motor is not rotated when the separation sensor 110 detects the trailing edge of the preceding document s-1. Rather, when the register sensor 111 detects the trailing edge of the preceding document s-1, the pickup motor is again rotated to rotate the separating roller of the separator 102, thereby feeding the following uppermost document s-2 of the batch of documents S to the separator 102 (refer to FIG. 7). The leading edge of the separated document s-2 is detected by the separation sensor 110. When the leading edge of the document s-2 is detected by the register sensor 111, the pickup motor is stopped to stop the rotation of the pickup roller and the separating roller to perform the bias correction of the following document s-2 (refer to FIG. 8). After the spacing from the preceding document s-1 becomes a specified value, the paper feed motor and the read motor are activated to feed the following document s-2 to the reading position R via the first register roller 103, the second register roller 104, and the first feed roller 105.

[Operation Display Device]

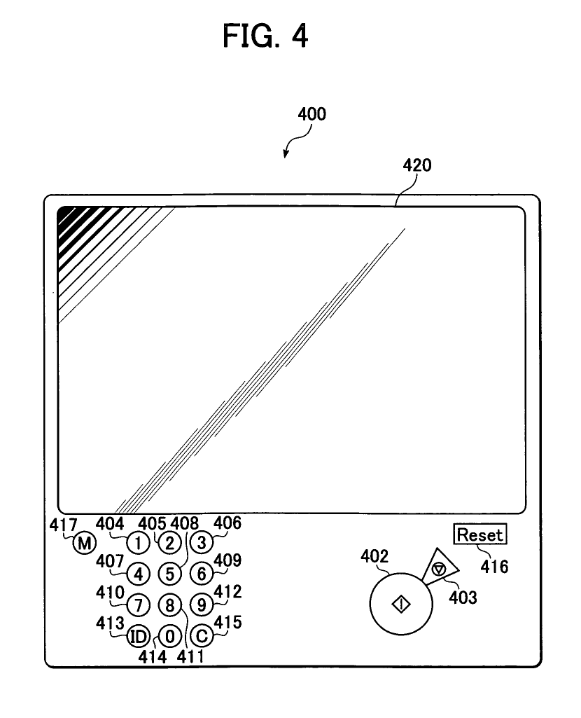

FIG. 4 shows the operation display device 400 of the imaging device of FIG. 1.

The operation display device 400 is a user interface that includes a start key 402 for starting the imaging operation, a stop key 403 for stopping the imaging operation, numerical keys 404-412 and 414 for numerical setting, an ID key 413, a clear key 415, a reset key 416, and a maintenance key 417. The display device 400 also has a liquid-crystal display 420 having a touch panel at the upper part, on which soft keys can be set.

[Mode Setting Flow]

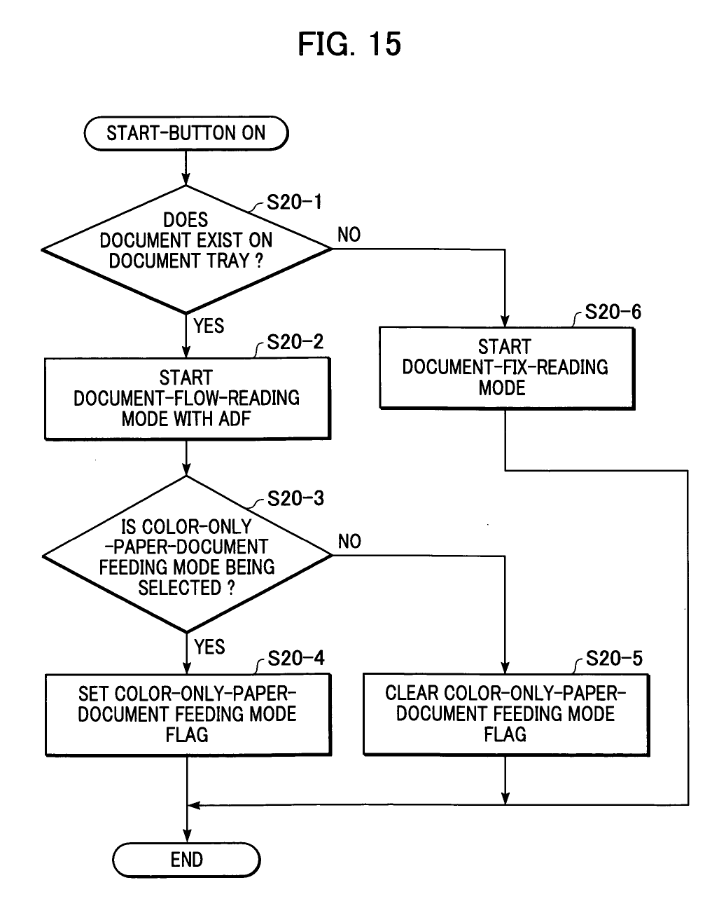

FIG. 15 is a flowchart for setting a color-only-paper-document feeding mode in accordance with one embodiment of the present invention.

When the CPU circuit section 150 has determined that a user has pushed the start key 402 of the operation display device 400, the CPU circuit section 150 starts the operation for reading documents and the document-set sensor 114 determines the presence of documents on the document tray 120 (S20-1). In step S20-1, if the document-set sensor 114 determines YES (that there is a document on the document tray 120), a document-flow-reading mode (a document reading operation using the automatic document feeder 100) is started (S20-2).

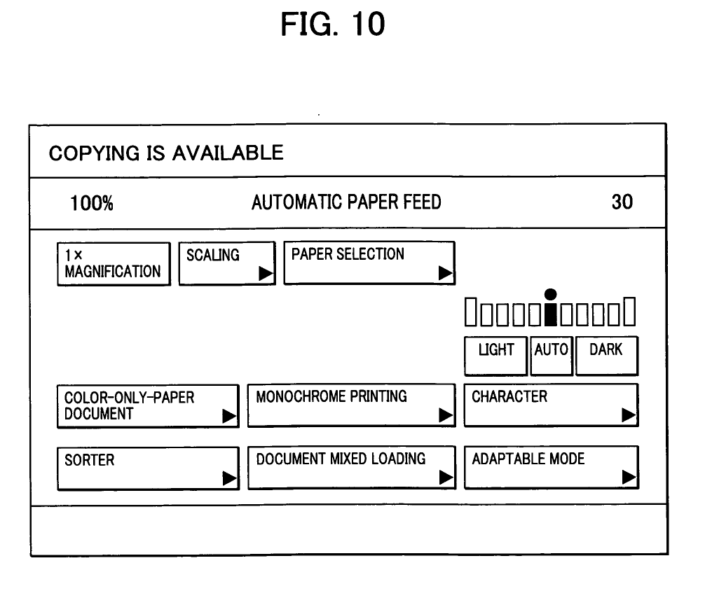

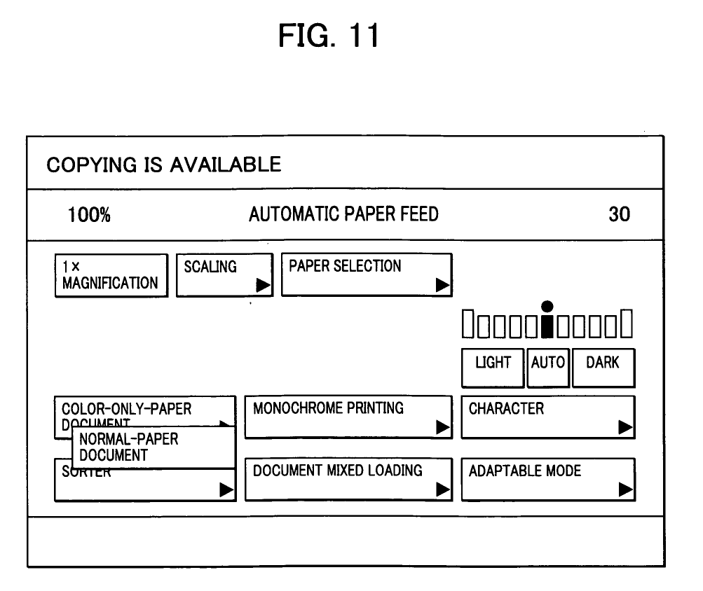

Next, a determination is made whether or not the user has set the color-only-paper-document feeding mode via the operation display device 400 (S20-3). The color-only-paper-document feeding mode, as shown in FIGS. 10 and 11, can be set by pushing a color-only-paper document key, which allows selection between a color-only-paper document mode and a normal-paper document mode. FIG. 10 is a drawing of the display screen 420 displaying that the color-only-paper document mode has been selected. FIG. 11 is a drawing of the display screen 420 showing that the normal-paper document mode is displayed as a choice after the color-only-paper document key has been pushed.

In step S20-3, if the color-only-paper-document feeding mode is selected, a color-only-paper-document feeding mode flag is set to the RAM 152 and a document reading operation is started (S20-4).

In step S20-3, if the color-only-paper-document feeding mode is not set, the color-only-paper-document feeding mode flag is cleared and a document reading operation is started (S20-5).

In step S20-1, if the document-set sensor 114 determines NO (that there is no document on the document tray 120), a document-fix-reading mode (a document reading operation not using the automatic document feeder 100) is started (S20-6).

[Second Mode-Setting Flow]

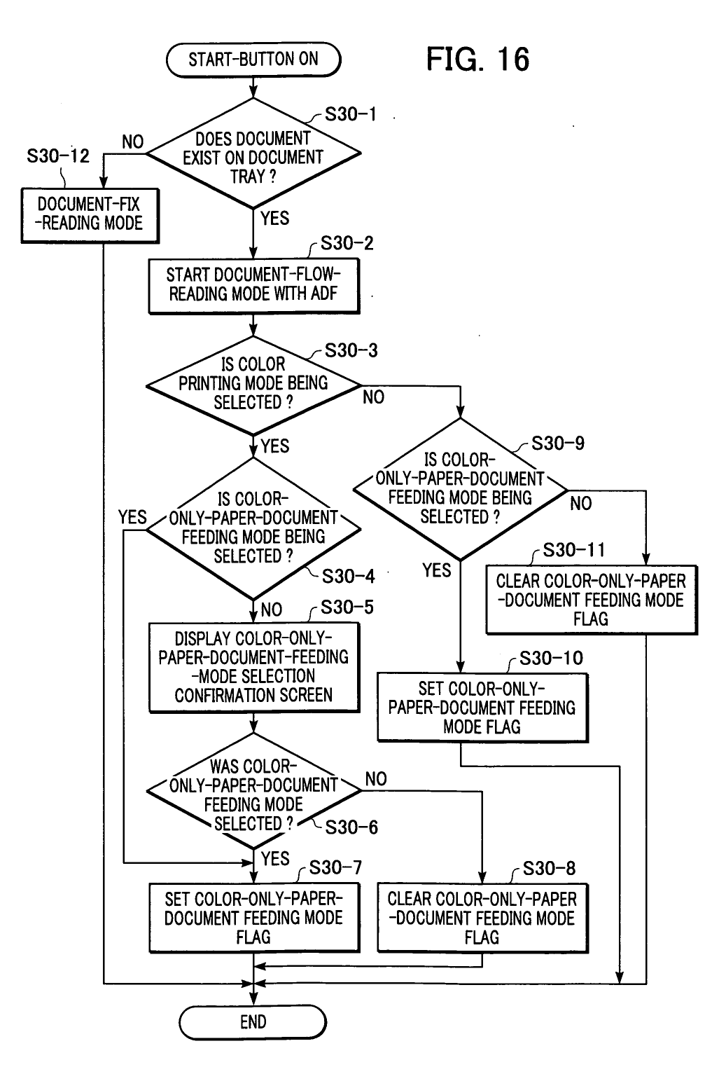

FIG. 16 is a flowchart illustrating steps for setting the color-only-paper-document feeding mode in accordance with another embodiment of the present invention. In this embodiment, when the color-only-paper-document feeding mode has not been set even though color printing is set, a user confirmation is made.

When the CPU circuit section 150 determines that the user has pushed the start key 402 of the operation display device 400, the operation for reading documents is started and the document-set sensor 114 determines the presence of documents on the document tray 120 (S30-1). In step S30-1, if the document-set sensor 114 determines YES (that there is a document on the document tray 120), a document-flow-reading mode (a document reading operation using the automatic document feeder 100) is started (S30-2).

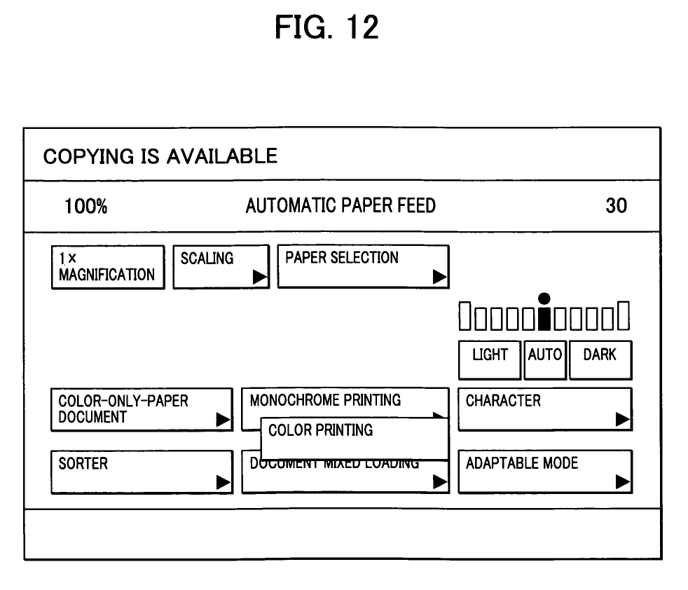

A determination is made whether or not the user has selected a color printing mode via the operation display device 400 (S30-3). To set the color printing mode, as shown in FIG. 12, a monochrome printing key can be pushed, which allows selection of the color printing mode. FIG. 12 is a drawing of the display screen 420 displaying a monochrome printing key being selected and a color printing key being displayed thereafter as a choice.

In step S30-3, if the color printing mode is selected, then a determination is made whether or not a color-only-paper-document feeding mode has been set (S30-4). In step S30-4, if the color-only-paper-document feeding mode is set, a color-only-paper-document feeding mode flag is set and the reading operation is started (S30-7).

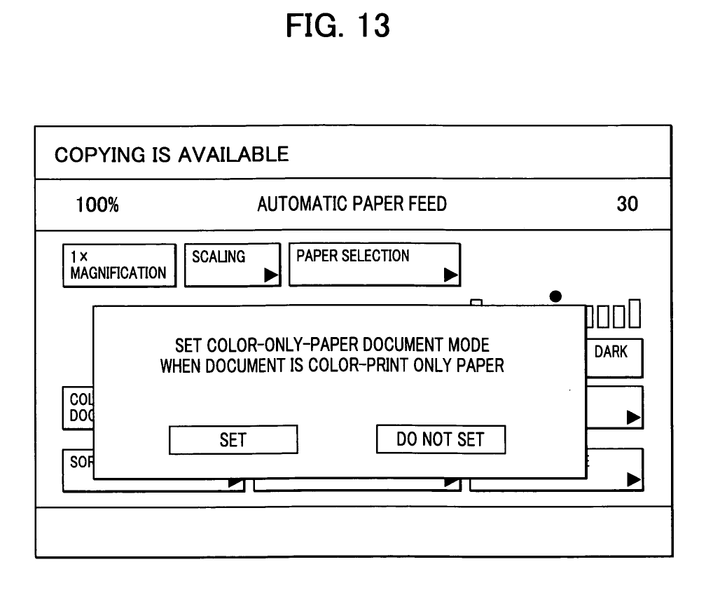

In step S30-4, if the color-only-paper-document feeding mode is not set, a user confirmation screen (refer to FIG. 13) is displayed prompting whether or not the reading operation should be continued without setting the color-only-paper-document feeding mode (S30-5). If the color-only-paper-document feeding mode is set by the user on the screen (S30-6), a color-only-paper-document feeding mode flag is set and a document reading operation is started (S30-7).

In step S30-6, if the color-only-paper-document feeding mode is not set by the user, the color-only-paper-document feeding mode flag is cleared and a document reading operation is started (S30-8).

In step S30-3, if the color printing mode is not set, a determination is made whether or not a color-only-paper-document feeding mode has been set (S30-9). In step S30-9, if the color-only-paper-document feeding mode is set, a color-only-paper-document feeding mode flag is set and a document reading operation is started (S30-10). In step S30-9, if the color-only-paper-document feeding mode is not set by the user, the color-only-paper-document feeding mode flag is cleared and a document reading operation is started (S30-11). In step S30-1, if the document-set sensor 114 determines NO (that there is no document on the document tray 120), a document-fix-reading mode (a document reading operation without using the automatic document feeder 100) is started (S30-12).

[Third Mode-Setting Flow]

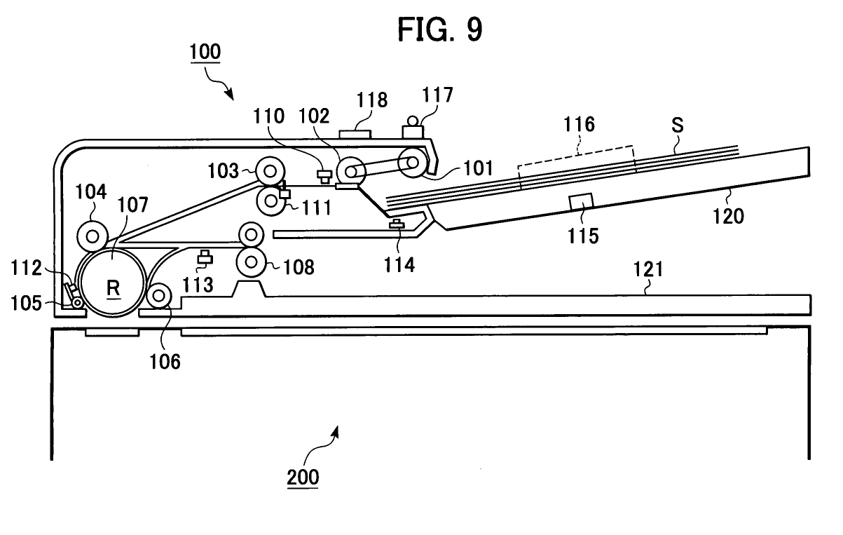

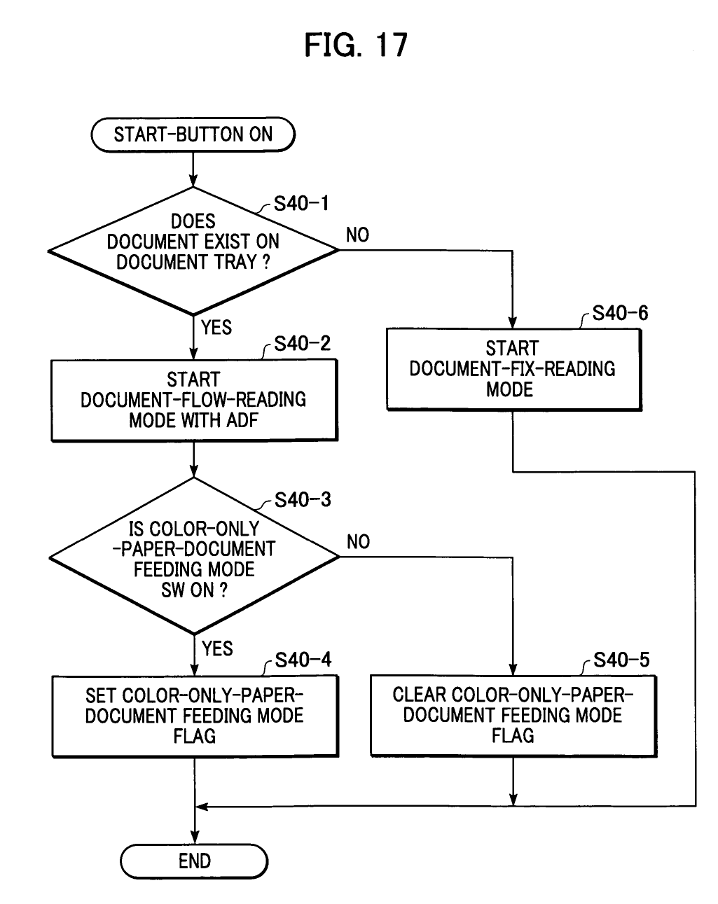

FIG. 17 is a flowchart illustrating steps for setting the color-only-paper-document feeding mode in accordance with another embodiment of the present invention. FIG. 9 is a schematic drawing of an automatic document feeder 100 in accordance with another embodiment of the present invention. In this embodiment, the automatic document feeder 100 includes on its upper surface a color-only-paper-document-feeding-mode setting switch 117.

When the CPU circuit section 150 determines that the user has pushed the start key 402 of the operation display device 400, the operation for reading documents is started and the document-set sensor 114 determines the presence of documents on the document tray 120 (S40-1). In step S40-1, if the document-set sensor 114 determines YES (that there is a document on the document tray 120), a document-flow-reading mode (a document reading operation using the automatic document feeder 100) is started (S40-2).

Then, a determination is made whether or not a color-only-paper-document feeding mode has been set via the setting switch 117 on the automatic document feeder 100 (S40-3). In step S40-3, if the color-only-paper-document feeding mode is set, a color-only-paper-document feeding mode flag is set and a document reading operation is started (S40-4).

In step S40-3, if the color-only-paper-document feeding mode is not set, the color-only-paper-document feeding mode flag is cleared and a document reading operation is started (S40-5).

In step S40-1, if the document-set sensor 114 determines NO (that there is no document on the document tray 120), a document-fix-reading mode (a document reading operation without using the automatic document feeder 100) is started (S40-6).

The color-only-paper-document-feeding-mode setting switch 117 is a toggle switch. When the user turns on the setting switch 117 to select the color-only-paper-document feeding mode, the user can confirm that the color-only-paper-document feeding mode has been set when a color-only-paper-document-feeding-mode setting display LED (not shown) on the automatic document feeder 100 lights up.

[Fourth Mode-Setting Flow]

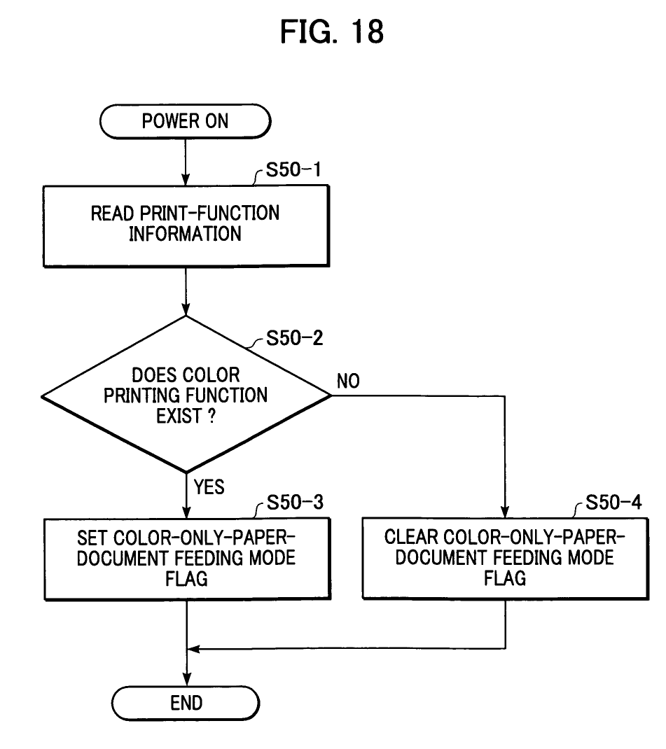

FIG. 18 is a flowchart illustrating steps for setting the color-only-paper-document feeding mode in accordance with another embodiment of the present invention. In this embodiment, the automatic document feeder 100 communicates with the imaging device main body 10 to determine color printing function/capability and if so, to set a color-only-paper-document feeding mode.

When power is turned on, the CPU circuit section 150 reads printing-capability information stored in a memory of the connected printer 300 (S50-1). In step S50-1, a determination is made whether or not the connected printer 300 has color printing function/capabilities (S50-2). In step S50-2, if the printer 300 has the color printing function, a color-only-paper-document feeding mode flag is set (S50-3).

In step S50-2, if the printer 300 has no color printing function/capabilities, the color-only-paper-document feeding mode flag is cleared (S50-4).

Such a configuration is effective when the automatic document feeder is mounted to a color imaging device and a monochrome imaging device. Specifically, when the automatic document feeder 100 is connected to an imaging device having a color recording function, it is likely that recording paper having surfaces with an oil constituent is used, regardless of whether color or monochrome printing is performed. Accordingly, the color-only-paper-document feeding mode is automatically set even if the user does not select the color-only-paper-document feeding mode every time, thus improving operability.

[Fifth Mode-Setting Flow]

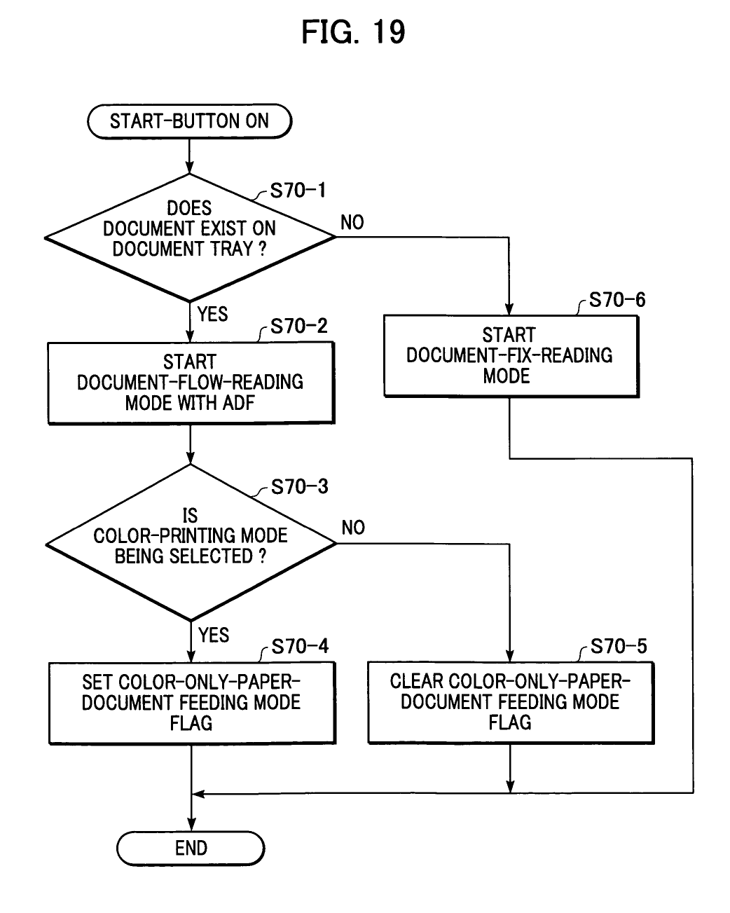

FIG. 19 is a flowchart illustrating steps for setting the color-only-paper-document feeding mode in accordance with another embodiment of the present invention. In this embodiment, the color-only-paper-document feeding mode is set depending on whether or not a color printing mode is set.

When the CPU circuit section 150 determines that the user has pushed the start key 402 of the operation display device 400, the operation for reading documents is started and the document-set sensor 114 determines the presence of documents on the document tray 120 (S70-1). In step S70-1, if the document-set sensor 114 determines YES (that there is a document on the document tray 120), a document-flow-reading mode (a document reading operation using the automatic document feeder 100) is started (S70-2).

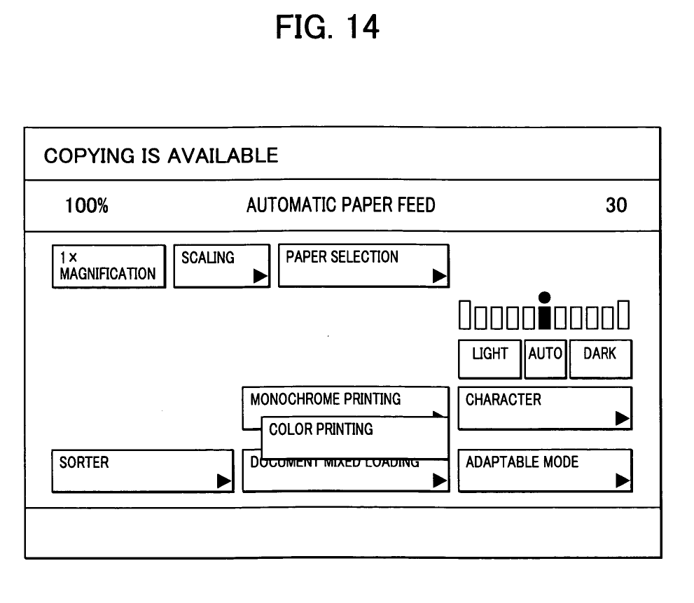

Then, a determination is made whether or not the user has set a color printing mode via the operation display device 400 (S70-3). To set the color printing mode, as shown in FIG. 14, a monochrome printing key can be pushed to allow selection of the color printing mode. FIG. 14 is a schematic drawing of the display screen 420 displaying selection of the monochrome printing mode. When the monochrome printing key is pushed, a color printing mode is displayed as a choice.

In step S70-3, if the color printing mode is set, a color-only-paper-document feeding mode flag is set and a document reading operation is started (S70-4).

In step S70-3, if the color printing mode is not set, the color-only-paper-document feeding mode flag is cleared and a document reading operation is started (S70-5).

In step S70-1, if the document-set sensor 114 determines NO (that there is no document on the document tray 120), a document-fix-reading mode (a document reading operation not using the automatic document feeder 100) is started (S70-6).

[Separating operation Flow]

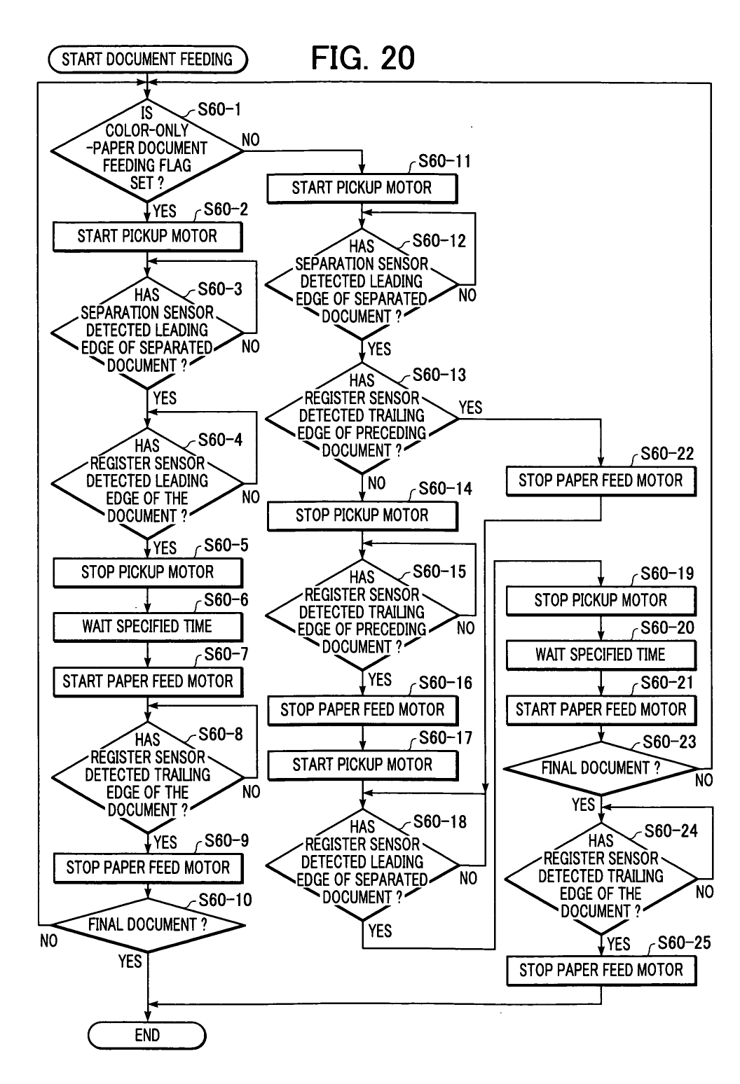

FIG. 20 is a flowchart illustrating steps of a document separating operation in accordance with one embodiment of the present invention.

When a document reading operation using the automatic document feeder 100 is started, the CPU circuit section 150 determines whether or not a color-only-paper-document feeding mode flag has been set in the RAM 152 (S60-1). The color-only-paper-document feeding mode flag is set under the conditions described in the color-only-paper-document feeding mode setting flow illustrated in FIGS. 15-19. In step S60-1, if the color-only-paper-document feeding mode flag is set, the CPU circuit section 150 starts the pickup motor rotating at a specified rate (S60-2). The rotation of the pickup motor causes the pickup roller 101 to rotate to move down onto the batch of documents S and causes the separating roller of the separator 102 to rotate. Thus, the feeding of the uppermost document of the batch of documents S to the separator 102 is started, and so only the uppermost document of the batch of documents S is fed by the upper separating roller and the lower separating pad of the separator 102.

The CPU circuit section 150 determines whether the separation sensor 110 has detected the leading edge of the separated document (S60-3). In step S60-3, if the separation sensor 110 has detected the leading edge of the document, the CPU circuit section 150 stands by until the register sensor 111 detects the leading edge of the document (S60-4). In step S60-4, when the register sensor 111 detects the leading edge of the document, the CPU circuit section 150 stops the pickup motor (S60-5). Thus, the rotation of the pickup motor and the separating roller is decreased or stopped and the leading edge of the document is brought into contact with the first register roller 103; thus, bias correction of the document is performed. The CPU circuit section 150 stands by for a specified period of time so as to stabilize the behavior of the documents and the behavior of the motor for the document bias correction and to maintain the distance from the immediately preceding separated document at a specified value (S60-6). After the specified time, the CPU circuit section 150 starts driving the paper feed motor rotating at a specified rate (S60-7). The rotation of the paper feed motor causes the first register roller 103 to rotate, and so the documents pass the first register roller 103, the second register roller 104, the first feed roller 105, and then to a reading position. The CPU circuit section 150 determines whether or not the register sensor 111 has detected the trailing edge of the document (S60-8). In step S60-8, if the register sensor 111 has detected the trailing edge of the document, the CPU circuit section 150 stops driving the paper feed motor (S60-9).

The CPU circuit section 150 determines via the document-set sensor 114 whether any document remains on the document tray 120, or whether all document reading is completed (S60-10). In step S60-10, if all document reading is completed, the separating operation is completed. In step S60-10, if all document reading is not completed, the process restarts at step S60-1 to start separation of the following document.

In step S60-1, if the color-only-paper-document feeding mode flag is not set, the CPU circuit section 150 starts the pickup motor rotating at a specified rate (S60-11). The rotation of the pickup motor causes the pickup roller 101 to rotate and to move downward and causes the separating roller of the separator 102 to rotate. Thus, the feeding of the uppermost document of the batch of documents S to the separator 102 is started; thus, only the uppermost sheet of the batch of documents S is fed by the upper separating roller and the lower separating pad of the separator 102.

The CPU circuit section 150 determines whether the separation sensor 110 has detected the leading edge of the separated document (S60-12). In step S60-12, if the separation sensor 110 has detected the leading edge of the document, the CPU circuit section 150 determines whether or not the register sensor 111 has detected the trailing edge of the preceding document (S60-13). In step S60-13, if the register sensor 111 has detected the trailing edge of the document, the paper feed motor is stopped (S60-22). Step S60-18 is then executed. In step S60-13, if the register sensor 111 has not detected the trailing edge of the preceding document, the CPU circuit section 150 stops the pickup motor (S60-14). The CPU circuit section 150 then determines whether the register sensor 111 has detected the trailing edge of the preceding document (S60-15). In step S60-15, if the register sensor 111 has detected the trailing edge of the preceding document, the CPU circuit section 150 stops driving the paper feed motor (S60-19). The CPU circuit section 150 then starts driving the pickup motor again to rotate it at a specified rate, thus restarting the feeding of the separated document (S60-17).

The CPU circuit section 150 then determines whether the register sensor 111 has detected the leading edge of the following/subsequent document (S60-18). In step S60-18, if the register sensor 111 has detected the leading edge of the document, the CPU circuit section 150 stops the pickup motor (S60-19). Thus, the rotation of the pickup motor and the separating roller is decreased or stopped and the leading edge of the document is brought into contact with the first register roller 103; thus, bias correction of the document is performed. The CPU circuit section 150 stands by for a specified time so as to stabilize the behavior of the documents and the behavior of the motor for the document bias correction and to make the distance from the immediately preceding separated document to a specified value (S60-20). The CPU circuit section 150 then starts driving of the paper feed motor to rotate at a specified rate (S60-21). The rotation of the paper feed motor causes the first register roller 103 to rotate, and so the documents pass the first register roller 103, the second register roller 104, the first feed roller 105, and then to a reading position.

The CPU circuit section 150 determines via the document-set sensor 114 whether any documents remain on the document tray 120, or whether all document reading has been completed (S60-23). In step S60-23, if all document reading has been completed, the CPU circuit section 150 determines whether the register sensor 111 has detected the trailing edge of the document (S60-24). In step S60-24, if the register sensor 111 has detected the trailing edge of the document, the CPU circuit section 150 stops driving the paper feed motor (S60-25). Thus, the separating operation is completed.

In step S60-23, if all document reading has not been completed, the process returns to step S60-1 to start separation of the following document.

As set forth hereinabove, according to the image reading device of the invention, oil-coated color document paper and specially coated document paper can be fed reliably. Furthermore, productivity can be improved for monochrome documents and in monochrome printing. Accordingly, a user is provided with a device capable of optimum separation feeding control for various document types including monochrome documents and color documents.

In addition to the color-only-paper-document feeding mode, it is possible to provide a structure in which an operator gives instructions on whether or not the surface of the document is smooth or to provide a sensor for sensing the smoothness of the surface of the document, thereby differentiating the separation timing depending on the sensor output.

While the present invention has been described with reference to what are presently considered to be the preferred embodiments, it is to be understood that the invention is not limited to the disclosed embodiments. On the contrary, the invention is intended to cover various modifications and equivalent arrangements included within the spirit and scope of the appended claims. The scope of the following claims is to be accorded the broadest interpretation so as to encompass all such modifications and equivalent structures and functions.

What is claimed is:

1. An automatic document feeder capable of feeding a batch of documents of varying material types to a document reader of an imaging device, the automatic document feeder comprising:
a document tray supporting the batch of documents thereon;
a separator separating a document from the batch of documents on the document tray;
an input device receiving data on the material type of the batch of documents; and
a separation controller operatively coupled to the separator and in communication with the input device, wherein the separation controller drives the separator to initiate separation of a document from the batch of documents in response to data received from the input device.

2. An automatic document feeder according to claim 1, wherein the data on the material type of the batch of documents received by the input device includes data on whether the batch of documents are color recorded paper or normal paper.

3. An automatic document feeder according to claim 2, wherein the separation controller delays the separator to initiate separation of a document from the batch of documents in response to receiving data that the documents are color-recorded paper.

4. An automatic document feeder according to claim 2, further comprising:
a transporter transporting documents, including first and subsequent documents separated by the separator, to the document reader;
the transporter including a sensor detecting a trailing edge of the first document;
the separation controller, responsive to the data that the batch of documents is color-recorded paper, drives the separator to initiate separation of the subsequent document from the batch of documents after the sensor detects the trailing edge of the first document; and
the separation controller, responsive to the data that the batch of documents is normal paper, drives the separator to initiate separation of the subsequent document from the batch of documents before the sensor detects the trailing edge of the first documents.

5. An automatic document feeder according to claim 1, wherein the input device is coupled to a user interface of the imaging device, wherein the input device receives the data on the material type of the batch of documents from the user interface.

6. An automatic document feeder according to claim 1, wherein the input device is coupled to a detector of the imaging device detecting color imaging capabilities of the imaging device, wherein the input device receives the data on the material type of the batch of documents from the detector.

7. An imaging device comprising:
a document reader for reading images from a batch of documents;
an automatic document feeder capable of feeding the batch of documents of varying material types to the document reader, the automatic document feeder including a document tray supporting the batch of documents thereon and a separator separating a document from the batch of documents on the document tray;
an interface receiving input data on the material type of the batch of documents; and
a controller operatively coupled to the interface and the separator, wherein the controller drives the separator to initiate separation of a document from the batch of documents in response to the input data on the material type received from the interface.

8. An imaging device of claim 7, further comprising:
a printer capable of recording images read by the document reader on recording sheets in a recording mode, including a color recording mode or a monochrome recording mode;
the interface receiving input data on the printing mode; and
the controller, being operatively coupled to the printer and responsive to the input data on the printing mode, controlling the printer to record in the color recording mode or the monochrome recording mode.

9. An imaging device of claim 8, wherein when the interface has received input data on the color recording mode and has not received input data on the material type, the interface queries for input data on the material type.

10. An automatic document feeder capable of feeding a batch of documents to a printer capable of selectively recording images in a color recording mode or a monochrome recording mode, the automatic document feeder comprising:
a document tray supporting the batch of documents thereon;
a separator separating a document from the batch of documents on the document tray; and
an input device receiving data on the selected recording mode; and
a separation controller operatively coupled to the separator and in communication with the input device, wherein the separation controller drives the separator to initiate separation of a document from the batch of documents in response to data received from the input device.

11. An automatic document feeder according to claim 10, wherein the separation controller delays the separator to initiate separation of a document from the batch of documents in response to receiving data that the recording mode is the color-recording mode.

12. An automatic document feeder capable of feeding a batch of documents to a printer, the automatic document feeder comprising:
a document tray supporting the batch of documents thereon;
a separator separating a document from the batch of documents on the document tray; and
a detector detecting a capability of the printer to record in color; and
a separation controller operatively coupled to the separator and in communication with the detector, wherein the separation controller drives the separator to initiate separation of a document from the batch of documents in response to the detector detecting the capability to record in color.

13. An automatic document feeder according to claim 12, wherein the separation controller delays the separator to initiate separation of a document from the batch of documents in response to the detector detecting that the printer is capable of recording in color.

14. A method for feeding a batch of documents in an image recording device, the method comprising the following steps:
setting material type of the batch of document;
separating a first document from the batch of documents; and
setting an interval for separating a subsequent document from the batch of documents responsive to the step of setting the material type of the batch of documents.

15. A method of claim 14, wherein the step of setting the interval includes setting the interval for color-recorded paper longer than the interval for normal paper.

16. A method according to claim 14, further comprising the following steps:
determining a recording-mode of the image recording device to be either color recording or monochrome recording; and
when the recording mode is determined to be color recording, alerting whether or not the material type of the batch of documents has been set.

17. A method for feeding a batch of documents in an image recording device, the method comprising the following steps:
detecting a recording mode of the image recording device to be either a color recording mode or a monochrome recording mode; and
separating a first document from the batch of documents; and
setting an interval for separating a subsequent document from the batch of documents responsive to detecting the recording mode.

18. A method of claim 17, wherein the step of setting the interval includes setting the interval for color recording longer than the interval for monochrome recording.

19. A method for feeding a batch of documents in an image recording device, the method comprising the following steps:
determining whether the image recording device has a color recording function;
separating a first document from the batch of documents; and
setting an interval for separating a subsequent document from the batch of documents responsive to the determining step.
